(19) United States
(12) Patent Application Publication
(10) Pub. No.: US 2015/0126635 A1
(43) Pub. Date: May 7, 2015

(54) METHOD FOR THE PRODUCTION OF POLYSULFONES, AND POLYSULFONES

(71) Applicant: EMS-PATENT AG, Domat/Ems (CH)

(72) Inventors: Hanns-Jörg Liedloff, Domat/Ems (CH); Andreas Bayer, Domat/Ems (CH); Pierre Dübon, Chur (CH)

(21) Appl. No.: 14/397,534

(22) PCT Filed: May 3, 2013
(86) PCT No.: PCT/EP2013/001311

§ 371 Date: Oct. 28, 2014

(30) Foreign Application Priority Data
May 11, 2012 (EP) 12167740.5

(51) Int. Cl. C08G 75/20

(52) U.S. Cl. CPC C08G 75/20
USPC 521/180; 528/174

(57) ABSTRACT

The invention relates to an improved method for producing polysulfones, in particular polyethersulfones (PES) and polyphenylene sulfones (PPSU), where N-methylpyrrolidone (NMP) or/and N-ethylpyrrolidone (NEP) is/are used as solvent/as solvents. The invention also relates to the obtained polysulfones that have a higher glass transition temperature, molded articles produced therefrom, and use thereof.

The present invention relates to an improved method for the production of polysulfones, in particular for the production of polyether sulfones (PESU) and polyphenylene sulfones (PPSU), the solvent being N-methylpyrrolidone (NMP) or/and N-ethylpyrrolidone (NEP). Likewise, the produced polysulfones which have an increased glass transition temperature, moulded articles produced herefrom and purposes of use are the subject of the invention.

Polysulfones belong to thermoplastic high-performance plastic materials and are used in a versatile manner in different spheres, such as for example automobile construction, medical technology, electronics, air travel and membrane technology. An overview of the possibilities of use of this polymer class is presented in the article by N. Inchaurondo-Nehm printed in 2008 in Edition 10 on pages 113 to 116 of the periodical “Plastic Materials”.

The methods known since the 1960s for production thereof provide the conversion of an aromatic dihydroxy compound with a dichlorodiaryl sulfone component in the presence of a base. In the course of the years, the production methods have been continuously developed further, NMP has proved to be a particularly suitable solvent. Alternatively, also NEP and possibly another N-alkylated pyrrolidone can be used. NMP or/and NEP require the use of potassium-, sodium- or calcium carbonate as base. Potassium carbonate (potash) is thereby preferred. A particular advantage of the combination of these N-alkylated pyrrolidones with the carbonates resides in the fact that the conversion of the aromatic dihydroxy compound with the dichlorodiaryl sulfone component is effected in one step and the technical apparatus expenditure for the polycondensation can be kept comparatively low.

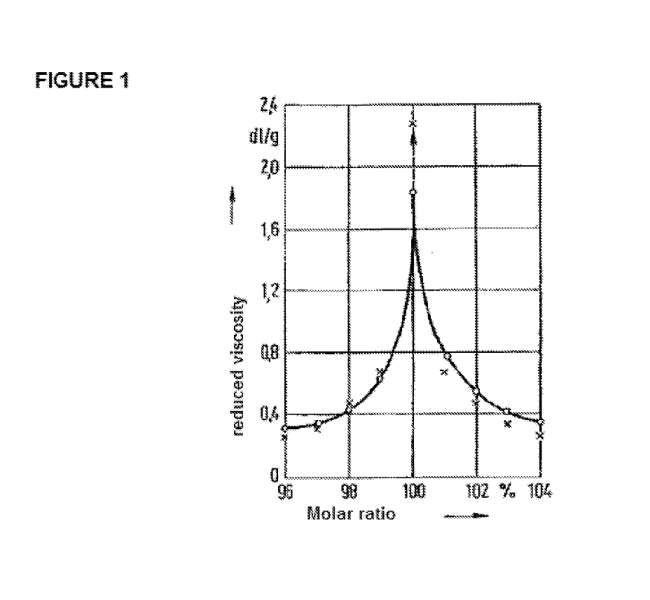

The equimolar conversion of the aromatic dihydroxy compound with the dichloroaryl sulfone compound leads, as can be anticipated in fact from purely theoretical consideration, to polymers with very high viscosity numbers, which are absolutely unsuitable in practice for use because of their properties. A high excess of one of the components leads however to products with a very low viscosity number (see in this respect also FIG. 1, which was taken from the Plastic Materials Handbook, Commercial Thermoplastics, Volume 3, High-performance Plastic Materials of 1994) and with poor mechanical properties.

FIG. 1: dependency of the viscosity number upon the molar ratio of the educts.

For this reason, in the recent past, methods have been established industrially for the production of polysulfones which provide the use of at least one of the mentioned components with a slight excess.

A series of commercial products such as e.g. PESU Radel A304P or PPSU Radel R-5000 NT are produced according to methods which use an excess of the dichlorophenyl sulfone component, generally dichlorodiphenyl sulfone (=DCDPS). The fact that DCDPS was used in excess for the production of these products emerges from the relatively high chlorine content of these polysulfones, at approx. 0.3 percent by weight, and the concentrations of chlorophenyl- or chlorine end groups which were calculated therefrom and are more than 80 mmol/kg polymer. In accordance with the high proportion of chlorine end groups of these Radel types, the hydroxyphenyl- or hydroxy end group concentrations thereof are less than 20 mmol/kg polymer. Determination of these phenolic OH groups was effected according to the method described by A. J. Wnuk; T. F. Davidson and J. E. McGrawth in Journal of Applied Polymer Science; Applied Polymer Symposium 34; 89-101 (1978). Because of the comparatively low hydroxy end group concentrations, alkylation of the hydroxyl groups with methylchloride or other alkyl halides is dispensed with in the case of the Radel types. This was verified by ¹H-NMR-spectroscopic tests on solutions of these polysulfones in CDCl₃ (apparatus: 400 MHz spectrometer by the company Bruker), the method is explained in detail further on.

In contrast to the Radel A and R types, in the production of commercially available PESU and PPSU types, Ultrason E and Ultrason P (as described in WO 2010/112508 A1), DCDPS is used in deficit. The excess, resulting therefrom, of bivalent phenols 4,4′-dihydroxydiphenyl sulfone (bisphenol S) or 4,4′-biphenol(4,4′-dihydroxydiphenyl=DHDP) makes methylation necessary, as the results of end group analyses, listed in the following table, show.

TABLE 1*
End groups of commercially available polysulfones

| | | | | | Chlorine | Viscosity |
|---|---|---|---|---|---|---|
| | | End group concentrations [mmol/kg] | | | content | number |
| Type | Polymer | Chlorophenyl- | Hydroxyphenyl- | Methoxyphenyl- | [ppm] | [ml/g] |
| Radel | PESU | 90 | 15 | — | 3200 | 51 |
| A304P | | | | | | |
| NT | | | | | | |
| Radel | PESU | 106 | 26 | — | 3800 | 42 |
| A704P | | | | | | |
| NT | | | | | | |
| Ultrason | PESU | 42 | 7 | 72 | 1500 | 56 |
| E2020P | | | | | | |
| Radel R | PPSU | 86 | 15 | — | 3200 | 71 |
| 5000 NT^{a} | | | | | | |
| Ultrason | PPSU | 141 | 7.5 | 29 | 5000 | 67 |
| P 3010^{b} | | | | | | |
| Ultrason | PPSU | 17 | 8 | 112 | 600 | 67 |
| P 3010^{c} | | | | | | |

*determination of the end group concentrations, of the chlorine content and of the viscosity number was effected according to the methods described further on,
^{a}Tg: 220° C. according to data sheet of the manufacturer;
^{b}(batch number of the analysed PPSU: 0245576770), T_{g}: 223° C. determined as indicated below;
^{c}as described in WO2010/112508 A1.

The advantage of the methods which provide a DCDPS excess resides in the fact that a reaction step, namely the alkylation of hydroxyphenyl end groups usually with the methylchloride categorised as carcinogenic can be dispensed with and consequently the material- and process costs can be reduced. One disadvantage of these methods resides in their lower tolerance relative to process interruptions. In concrete terms, the disadvantage resides in the fact that the salt-containing polymer solutions which are found in the reactor, i.e. not yet freed of solid materials by means of filtration, are inclined towards increases in viscosity and molecular weight with prolonged dwell times in the reactor. In the case of a sufficiently long dwell time in the reactor, there are produced, irrespective of whether the products are methylated or the methylation step is dispensed with (see CE4 and CE5), extremely highly-viscous polymers which are completely unusable for any of the above-described applications so that a material loss which can no longer be compensated for with the present state of knowledge results.

The method for the production of polybiphenyl sulfone polymers, described in WO 2010/112508 A1, solves the above-mentioned problem with control of the viscosity number by using a slight excess of the aromatic dihydroxy compound. NMP is used as solvent and potassium carbonate as base. In addition, reference is made explicitly to the fact that reaction control is possible without an additional entrainer if NMP is used as solvent.

The older EP 0135 130 A2 describes a method for the production of polyethers by polycondensation of essentially equivalent quantities of 2,2-bis-(4-oxyphenyl)-propane, which can be replaced partially by further biphenols, with bis-(4-chlorophenyl)-sulfone which can be replaced partially by further dihalobenzene compounds. This document teaches the person skilled in the art firstly to preform the bisphenols with potassium carbonate and to supply the bishalogen compound after removal of water by distillation and to implement the polycondensation. According to the disclosure of this document, azeotrope formers are not required, a negative effect on the reaction speed and the viscosity number is shown for toluene as entrainer on the basis of experimental data.

Also the older EP 0 347 669 A2 describes a method for the production of high-molecular, aromatic polyether sulfones from diphenols and dihaloarylenes which provides the use of the educts in equimolar quantities.

Furthermore, the method described in EP 0 347 669 A2 is characterised in that N-alkylated acid amides are used as solvent and hence the water produced during the reaction is removed azeotropically at the same time. This document teaches the use of N-alkylated acid amides themselves as azeotrope former.

In addition, CA 847963 A describes the use of sulphoxides and/or sulfones as solvent in the production of polyaryl sulfones.

Methods which provide an excess of the aromatic dihydroxy compound lead to products which are preferably alkylated for stabilisation, in contrast to the DCDPS-regulated polysulfones, on the basis of their high hydroxyphenylene end group concentration. In addition, a high quantity of methylchloride (MAK=50 ml/m³) which is acutely toxic and categorised as carcinogenic is used in practice.

The mentioned methods from the state of the art, irrespective of in what ratio the aromatic dihydroxy- and the aromatic dichlorosulfone compound are used, have the following common disadvantage:

the preferred implementation of the polycondensation of polysulfones [PESU, PPSU and polysulfone (based on DCDPS and bisphenol A)], supported by the state of the art, in the absence of an entrainer for separating the water produced during the conversion, has an excessively long reaction duration as a result, which has a disadvantageous effect on productivity and dimensioning of the polycondensation reactors and reduces the economic efficiency of the method. In addition, the polysulfones produced in this way have only inadequate thermal stabilities.

It was therefore the object of the present invention to make available an improved production method for polysulfone polymers, which overcomes the disadvantages of the state of the art. On the one hand, the above-described synthesis phenomenon is intended to be suppressed by a suitable measure. On the other hand, it is the object of the invention to reduce the requirement for toxic methylchloride. Likewise, it was the object of the present invention to indicate polysulfones with improved thermal properties, in particular increased glass transition temperatures.

This object is achieved, with respect to a production method, by the features of patent claim 1, with respect to a polysulfone, by the features of patent claim 16, with respect to a thermoplastic moulding compound or a moulded article, by the features of patent claim 18 or 19 and also, with respect to the possibilities for using polysulfones, by the features of patent claim 20, the independent patent claims respectively thereby represent advantageous developments.

The method according to the invention allows the production of polysulfone polymers, in which a component A, comprising at least one aromatic dihydroxy compound, selected from the group consisting of 4,4′-dihydroxybiphenyl and/or bisphenol S, is converted with a component B, comprising at least one bis-(haloarene)sulfone, preferably 4,4″-dichlorodiphenyl sulfone, in the presence of a base which reacts with the reaction mixture with formation of water,

>0.99 to <1.01 equivalent of component A being used relative to 1.0 equivalent of component B,
the conversion being implemented in a solvent, comprising N-alkylated pyrrolidones, there being added to this reaction mixture from 0 to 12 percent by weight, relative to the total weight of components A and B, of the base and of the solvent, of at least one entrainer with a boiling point of greater than 130° C., and
at least one regulator (component D) which is a monovalent phenol being added before or during the conversion of component A with component B.

For the mechanistic progress of the reaction, the idea is that the base firstly activates the dihydroxy compound (component A) by deprotonation. After substitution of the chlorine atoms of the dichlorine compound (component B) by the anion of component A, hydrogen chloride is produced according to the formula, which is neutralised by the base with formation of the corresponding salt and water. When using e.g. potash as base, carbonic acid, which decomposes into water and carbon dioxide, and potassium chloride are thereby produced.

The water produced is thereby removed from the reaction mixture by distillation using an entrainer, in a preferred embodiment. There is understood thereby by an entrainer, preferably a substance which forms an azeotrope with water and it enables the water to be separated from the mixture. The entrainer is thereby materially different from the solvent. Preferably, the entrainer does not represent a solvent for the produced polysulfone whilst the solvent has no entrainer character.

It was established that polysulfone polymers in the viscosity number range useable for commercial use are obtained if components A and B are used equimolarly—i.e. in the above-defined ratio and a regulator (component D) which is a monovalent phenol is added.

Within the scope of the tests relating to the present invention, the above-discussed behaviour, expected from the theoretical point of view, for the equimolar conversion of the aromatic dihydroxy component with the dichloroaryl sulfone component was confirmed. The obtained polymers have high viscosity numbers which are unusable for use in practice (see also comparative example 1 (CE 1)).

Furthermore, completely surprisingly, an increase in the glass transition temperature of the polysulfones produced according to the method, relative to the polysulfone polymers known from the state of the art, was able to be observed.

Furthermore, it was surprising that if a monochloroaryl component is used as component D, the polysulfones produced have a significant molecular weight increase (CE 6) which has an extremely negative effect on the use of the products. The choice of regulator is therefore, contrary to expectation, crucial for the quality of the obtained products.

A preferred embodiment of the method provides that the regulator used, i.e. component D, is a monovalent phenol with a PKa value of the phenolic proton of <12, preferably <11, particularly preferred <10, the phenol being selected in particular from the group consisting of 4-phenylphenol, 4-tert-butylphenol, 4-tritylphenol, ortho-cresol, meta-cresol, para-cresol, 2,3-dimethylphenol, 2,4-dimethylphenol, 2,5-dimethylphenol, 2,6-dimethylphenol, 3,4-dimethylphenol, 3,5-dimethylphenol, mesitol, tymol, para-amylphenol, ortho-amylphenol, meta-amylphenol, para-isopropylphenol, meta-isopropylphenol, ortho-isopropylphenol, para-n-butylphenol, ortho-n-butylphenol, meta-n-butylphenol, para-n-heptylphenol, para-n-heptylphenol, meta-n-heptylphenol, para-n-octylphenol, ortho-n-octylphenol, meta-n-octylphenol, para-n-nonylphenol, ortho-n-nonylphenol, meta-n-nonylphenol, para-n-dodecylphenol, meta-n-dodecylphenol, ortho-n-dodecylphenol, 5-indanol, 1-hydroxynaphthalene and/or 2-hydroxynaphthalene.

Likewise mixtures of 2 or more of the previously mentioned phenols can be used.

It is thereby particularly preferred that 30-90 μmol regulator (component D), preferably 40-70 μmol, particularly preferred 45-60 μmol, of component D (regulator) is used, wherein the quantity data should be understood in μmol regulator to g resulting polymer.

Preferably, the reaction is implemented using an entrainer based on alkyl aromatics, in particular alkylbenzenes.

Furthermore, during and/or after conversion of component A with component B, partial or complete de-watering of the reaction mixture is implemented preferably, for preference by azeotropic distillation of the water together with the entrainer.

It was established by the inventors that in particular alkylbenzenes which have a boiling point of greater than 130° C. have an excellent entrainer function. They reduce the reaction times significantly and hence increase the economic efficiency of the method. In view of the negative results from the state of the art with the simplest alkylbenzene toluene (boiling point 111° C.), this knowledge is extremely surprising.

Preferred entrainers are selected from the group consisting of ortho-xylene, meta-xylene, para-xylene, mixtures of xylene isomers, commercial xylene, ethylbenzene, 1,3,5-trimethylbenzene, 1,2,4-trimethylbenzene and/or mixtures thereof. Commercial xylene is particularly preferred, by which there is understood a mixture of xylene isomers, which occur for example in reforming- or steam cracker processes and comprise in addition ethylbenzene. Reference is made to the fact that the solubility of the polysulfone polymers and also of the educts for their production in the entrainers is very low and these should not be understood as solvent therefore in the sense of the present invention. In addition, the N-alkylpyrrolidones which are outstandingly suitable as solvent have only an inadequate entrainer function and should in no way be understood as entrainer in the sense of the present invention.

A non-restricting selection of alkyl aromatics according to the present invention is listed in the following table together with their boiling temperatures.

TABLE 2
selection of entrainers according to the present invention

| Entrainer | Boiling temperature [° C.] |
|---|---|
| o-xylene(1,2-dimethylbenzene) | 144 |
| m-xylene(1,3-dimethylbenzene) | 139 |
| p-xylene(1,4-dimethylbenzene) | 138 |
| Ethylbenzene | 136 |
| Mixture of o-, m- and p-xylene and | 138.5 |
| ethylbenzene*⁾ | |
| Cumene = isopropylbenzene | 152 |
| Pseudocumene = 1,2,4-trimethylbenzene | 169 |
| Mesitylene = 1,3,5-trimethylbenzene | 165 |

*⁾such mixtures are isolated from pyrolysis benzene (from steam cracker processes) or from reformate benzene (from reforming processes) and are subsequently termed commercial xylene.

This preferred embodiment enables more efficient process control by partial or complete removal of the water produced during the conversion of component A with component B, preferably by distillation-off from the reaction mixture and the polysulfone which is being produced or is produced and contained therein. The water produced during the reaction can be removed together with the entrainer out of the reaction mixture, preferably by distillation of the azeotrope. A partial, preferably complete removal of the produced reaction water from the reaction mixture is thereby achievable.

There is thereby understood by “complete” water removal that more than 95% of the formed reaction water is separated, preferably more than 98%. In this context, in the case of partial or complete removal of the entrainer, effected at this point, the term is “de-watering”. In the case where only a part of the entrainer is removed, for example distilled off, the remaining or excess entrainer can also be removed from the reaction mixture, for example likewise by distillation, at a later time.

In a particularly preferred embodiment, the entrainer is guided in the circulation. Water and entrainer are separated in the condensate and form a phase boundary, the water can be separated for example via a water separator outside the reactor in which the conversion of component A and component B is implemented. With the separated water, generally also a small part of the entrainer is thereby removed from the reaction mixture.

The quantity of entrainer is 0 to 12 percent by weight, preferably 4 to 10 percent by weight and particularly preferred 6 to 9 percent by weight, relative to the total weight of all the components, including the solvent and the base.

In the sense of the present invention, component A consists of at least one aromatic dihydroxy compound and comprises at least 4,4′-dihydroxybiphenyl and/or bisphenol S, 4,4′-dihydroxybiphenyl being preferred. Furthermore, component A can comprise further compounds, such as e.g. dihydroxybiphenyls, in particular 2,2′-dihydroxybiphenyl; further bisphenyl sulfones, in particular bis(3-hydroxyphenyl sulfone); dihydroxybenzenes, in particular hydroquinone and resorcine; dihydroxynaphthalenes, in particular 1,5-dihydroxynaphthalene, 1,6-dihydroxynaphthalene and 1,7-dihydroxynaphthalene; bisphenylether, in particular bis(4-hydroxyphenyl)ether and/or bis(2-hydroxyphenyl)ether; bis-phenylsulphides, in particular bis(4-hydroxyphenyl)sulphide; bisphenylketones, in particular bis(4-hydroxyphenyl)ketone; bisphenylmethanes, in particular bis(4-hydroxyphenyl)methane; bisphenylpropanes, in particular 2,2-bis(4-hydroxyphenyl)propane (bisphenol A); bisphenylhexafluoropropanes, in particular 2,2-bis(3,5-dimethyl-4-hydroxyphenyl)hexafluoropropane; and/or mixtures thereof.

In one embodiment of the present invention, component A comprises at least 50 percent by weight of 4,4′-dihydroxybiphenyl or at least 50 percent by weight of bisphenol S, preferably at least 80 percent by weight of 4,4′-dihydroxybiphenyl or bisphenol S are contained in component A, in a particularly preferred embodiment, component A is 4,4′-dihydroxybiphenyl or bisphenol S.

The component B which is used in the sense of the present invention comprises, in a particularly preferred embodiment, (4,4′-dichlorodiphenyl sulfone, the additional use of other dihaloarene sulfone compounds or replacement of 4,4-dichlorodiphenyl sulfone by other dihalorene sulfone compounds are likewise in accord with the invention.

The conversion of component A and B is effected preferably between 80 and 250° C., further preferred between 100 and 220° C. and particularly preferred between 150 and 210° C.

The conversion of component A and B, expressed by the timespan in which reaction water is produced, is effected preferably between 1 and 6 hours, preferably between 1.5 and 5 hours and particularly preferred between 2 and 4 hours.

It is further preferred if >0.995 to <1.05, preferably >0.999 to <1.001 equivalent of component A, relative to 1.0 equivalent of component B, in particular equimolar quantities of component A and component B, are used.

By reaction control according to the conditions of the method according to the invention, it is possible to obtain conversions of greater than 96%, preferably greater than 98% and particularly preferred greater than 98.5%. The conversions in the sense of the present invention relate to the molar proportion of the converted reactive chlorine- and hydroxy end groups of components A and B.

The conversion of components A and B is effected preferably in a solvent which comprises mainly N-alkylated pyrrolidones. A variant in which exclusively NMP or/and NEP is used as solvent is particularly preferred. An embodiment in which exclusively NMP is used as solvent is preferred in particular.

According to the present invention, the concentration of components A and B in the solvent is from 10 to 60 percent by weight, preferably from 15 to 50 percent by weight and particularly preferred from 20 to 40 percent by weight.

In the sense of the present invention, the conversion of component A with component B is effected in the presence of a base. This base has the purpose of converting the aromatic hydroxy component into the more reactive phenolate form. Preferred bases are alkali- or alkaline earth hydrogen carbonates, alkali- or alkaline earth carbonates or mixtures of the previously mentioned compounds, in particular sodium carbonate, potassium carbonate and calcium carbonate, potassium carbonate being particularly preferred. In a particularly preferred embodiment, water-free potassium carbonate is used. According to a further preferred embodiment, water-free potassium carbonate having a particle size of less than 250 lam is used. According to the present invention, 1.0 to 1.5 equivalent of the base, preferably 1.005 to 1.1 equivalent, particularly preferred from 1.008 to 1.05 equivalent of the base, respectively relative to 1.0 equivalent of component A, is used.

Although the pure polysulfones are known as very oxidation-stable compounds, the exact opposite applies as the inventors have established for the solutions of these polymers in NMP or in another solvent. Precisely due to traces of oxygen, the dissolved polysulfones, under the production conditions, i.e. at temperatures of approx. 150 to approx. 240° C., are decomposed very rapidly to form completely unusable, i.e. greatly discoloured and highly viscous products. The viscosity of oxidatively damaged polysulfones passes firstly through a minimum before, in the extreme case, crosslinking to form neither flowable nor meltable materials occurs. Therefore, the implementation of the polycondensation and of all subsequent steps under an extensively oxygen-free inert gas atmosphere is absolutely necessary. As protective gases, nitrogen and argon with an oxygen content of less than 100 ppm, preferably less than 10 ppm, in particular less than 1 ppm, have proved their worth.

A preferred embodiment of the present invention provides, during and/or after conversion of components A and B, single or multiple conversion of the polysulfone polymer with at least one aliphatic monohalogen compound (component C). The still present hydroxy groups are etherised in this reaction step and the polymer is protected from synthesis or decomposition reactions. In addition, this reaction step has a positive effect on the yellowing properties of the polymer. For preference, alkyl halides and particularly preferred alkyl chlorides are used, i.e. alkylation takes place during the conversion with component C. In a particularly preferred embodiment, methylchloride is used as component C.

The conversion with component C should be implemented preferably before the distillative removal of the excess entrainer (entrainer distillation).

The temperature during the conversion with component C, according to the present invention, is between 140 and 215° C., preferably between 160 and 205° C., particularly preferred between 180 and 200° C. Component C can be supplied continuously as a gas flow but also can be applied in batches. Provided component C is used in liquid form, a continuous feed is preferably effected. The conversion with component C is implemented between 15 and 200 minutes, preferably between 25 and 120 minutes, and particularly preferred between 30 and 60 minutes.

It has proved to be advantageous to filter off the potassium chloride produced during the conversion of component A and B after the reaction is completed. Provided a conversion with component C is effected, it is advantageous to implement the filtration only after this second reaction step. The filtration is effected after diluting the reaction mixture with the solvent used for the conversion to twice the volume.

The process duration in the sense of the present invention is for all polysulfones except PESU (bisphenol S as dihydroxy component) below 400 minutes, preferably below 350 minutes and particularly preferred below 310 minutes. For PESU, the process duration is somewhat higher because of the lower reaction speed and is below 450 minutes, preferably below 410 minutes and particularly preferred below 380 minutes. The term process duration is explained in the experimental part and, in addition to the duration of the conversion of component A and B, comprises also the steps of methylation and distillative removal of the excess entrainer.

The viscosity numbers of the polysulfones produced according to the method of the present invention are from 35 to 85 ml/g, preferably from 42 to 80 ml/g and particularly preferred from 45 to 70 ml/g, measured according to ISO 307, as explained further on in more detail.

The excess entrainer is removed, in a preferred embodiment, before precipitation of the polysulfone.

Precipitation of the obtained polysulfone can be effected, within the scope of the present invention, according to the techniques which are common for this class of substance. The precipitant is selected preferably from the group consisting of water, mixtures of water and NMP, water and NEP and/or alcohols with 2-4 C atoms. The proportion of the NMP or NEP in the mixtures with water is up to 25 percent by weight. For particular preference, the temperature of the precipitant is 80° C. if the precipitation is effected at normal pressure. At higher pressures, as can be required by design of the apparatus used for the precipitation, the temperature of the precipitant is higher than 100° C.

Furthermore, the present invention relates to a polysulfone polymer which is producible according to the previously described method.

The polysulfone polymer according to the invention thereby represents a polycondensate made of the monomers component A and component B which is terminated at the chain ends inter alia with groups which originate from component D.

In contrast to the polysulfones known from the state of the art, the polysulfones according to the invention surprisingly have better thermal properties, they display a higher glass transition temperature. These improved properties can be attributed to the production method according to the invention.

Preferred polysulfone polymers are distinguished by a glass transition temperature (T_{g}, measured according to ISO 11357 part 1 and 2 as described below) of more than 223° C., preferably more than 224° C., particularly preferred from 225° C. to 230° C.

According to the invention, likewise a thermoplastic moulding compound, comprising at least one previously mentioned polysulfone polymer is indicated. In addition, the invention provides moulded articles, produced from a thermoplastic moulding compound according to the invention, in particular in the form of fibres, films, membranes or foams. The invention likewise relates to possibilities for use of a polysulfone polymer according to the invention or of a thermoplastic moulding compound according to the invention for the production of moulded articles, fibres, films, membranes or foams.

The present invention is explained in more detail with reference to the following examples which illustrate the invention but are not intended to restrict the scope thereof.

The materials listed in Table 3 were used in the examples and comparative examples.

TABLE 3
Materials used

| Substance | Trade name | Abbreviation | Manufacturer |
|---|---|---|---|
| 4,4′-dihydroxybiphenyl | 4,4′-biphenol | DHDP | Si-Group; |
| | | | Newport, |
| | | | Tennessee, US |
| 4,4′-dichlorodiphenyl sulfone | 4,4′-dichlorodiphenyl sulfone | DCDPS | Ganesch |
| | | | Polychem. Ltd. |
| | | | Mumbai, India |
| 4-phenylphenol | 4-phenylphenol | — | Sigma Aldrich, |
| | | | Buchs, CH |
| 4-chlorodiphenyl sulfone | 4-chlorodiphenyl sulfone | — | Sigma Aldrich, |
| | | | Buchs, CH |
| potassium carbonate | potassium carbonate | — | EVONIK-Degussa |
| | | | GmbH; Lülsdorf, |
| | | | DE |
| methylchloride | methylchloride | MeCl | Sigma Aldrich, |
| | | | Buchs, CH |
| N-methylpyrrolidone | N-methylpyrrolidone | NMP | BASF AG, |
| | | | Ludwigshafen, DE |
| commercial xylene^{a)} | commercial xylene^{a)} | — | Total S.A., |
| | | | Courbevois, Paris |
| toluene | toluene | — | Sigma Aldrich, |
| | | | Buchs, CH |

^{a)}Proportion of ethylbenzene of <20%

Implementation of the Analytical Determinations and Sample Preparation

Sample Preparation

For preparation of the samples taken during or at the end of the polycondensations for implementation of the analyses, these were firstly precipitated with a large excess of water at a temperature of 80° C., the resulting polymer particles were then extracted twice with 100 times the quantity of water (21 to 20 g polymer) at 90° C. for 3 hours, dried for 14 hours at 100° C. in the vacuum drying cupboard and finally extracted for 16 hours in a high excess of boiling methanol (500 ml to 5 g polymer) and dried in a vacuum.

Determination of the Viscosity Numbers (VN)

Determination of the viscosity number in [ml/g] was effected according to ISO 307 at 25° C. on 1% solutions of the polymers in a 1:1 mixture of phenol and ortho-dichlorobenzene.

Determination of the Hydroxy End Group Concentrations

The hydroxy end groups were determined according to the method of Wnuk et al. which was already cited above.

Determination of the Methoxy End Group Concentrations

The methoxy end groups were determined by means of ¹H-NMR spectroscopy on a 400 MHz apparatus of the company Bruker. The signals of the aromatic protons and also the signal for the protons of the methoxy group were integrated, the sum of the integral value of the aromatic protons being set at 16. The methoxy end groups were then calculated with the following formula:

$$EG ( methoxy ) = \frac{integral ( methoxy ) \times 1000000}{M \times 3}$$

with
EG (methoxy): methoxy end groups in μaeq/g
Integral (methoxy): integral of the signal at 3.85 ppm (integral of the aromatic protons set at 16)
M: weight of the repetition unit of the polysulfone in g/aeq (PPSU: 400 g/aeq, PESU: 464 g/aeq)

Determination of the Chlorine Content

The chlorine content was determined by means of ion chromatography. Firstly, the samples were prepared as follows:

In order to determine the total chlorine content, decomposition of the sample was implemented with an oxygen decomposition apparatus of the company IKA. 100 mg of the sample was weighed into an acetobutyrate capsule, provided with ignition wire and connected to both electrodes of the decomposition apparatus. As absorption solution, 10 ml of 30% hydrogen peroxide was used. The ignition was effected at 30 bar oxygen. The decomposition solution was filtered, filled into vials and finally analysed by ion chromatography for chloride.

In order to determine the free chloride, 2.0 g sample in 50 ml methanol/water 1/1 was extracted overnight with reflux. The extraction solution was filtered, filled into vials and analysed by ion chromatography for chloride.

The ion chromatography was implemented with the following parameters:
Apparatus: ICS-90 (company Dionex)
Column: IonPac AS12A Analytical Column (4×200 mm)
Eluent: 2.7 mM sodium carbonate
   0.3 mM sodium hydrogen carbonate
Detection: Conductivity detector
Flow: 1 ml/min.

The evaluation was effected with the method of the external standard. For this purpose, a calibration curve was determined from 3 different chloride solutions of known concentration.

Determination of the Chlorine End Group Concentrations

The chlorine end group concentrations were calculated according to the following formula via the chlorine content:

$$EG ( chlorine ) = \frac{[ chloride ( total ) - chloride ( free ) ]}{35.5}$$

with
EG (chlorine): chlorine end groups in μeaq/g
chloride (total): chloride concentration of the decomposition solution in ppm
chloride (free): chloride concentration of the extraction solution in ppm

Determination of the Glass Transition Temperature (T_{g})

Determination of the glass transition temperature was effected on a DSC 2920 (differential scanning calorimeter) of the company TA Instruments according to ISO Standard 11357 Part 1+2. Nitrogen was used as scouring gas and indium (Smpₒₙₛₑₜ:156.6° C., ΔH: 28.71 J/g) was used as calibration substance. 10 mg of the sample was weighed into a crucible made of aluminium and this was sealed. The sample was then heated firstly at 20° C./min above the melting point of the sample, i.e. at least 10° C. higher than the end of the melting process, and was cooled after one minute at this temperature at 5° C./min to room temperature. Subsequently, heating took place again at 20° C./min above the melting point and quenching in solid carbon dioxide for determination of the glass transition temperature. The thermogram was evaluated with the program Universal Analysis of the company TA Instruments. The average of the glass transition range, which is indicated subsequently as T_{g}, was determined according to the “half height” method. In addition, the temperature at the onset was indicated in the examples.

### EXAMPLE 1

### E 1, Equimolar Use of Components A and B, 4-Phenylphenol as Chain Regulator, Commercial Xylene as Entrainer and Methylation

In a heatable autoclave of the company Büchi (agitated vessel type 4, 2.0 1, Büchi AG, Uster) with agitator, connections for distillation attachments, reflux cooler, water separator and inert gas supply line, 127.3 g (0.684 mol) 4,4′-dihydroxybiphenyl and 196.4 g (0.684 mol) 4,4′-dichlorodiphenyl sulfone (molar ratio DHDP:DCDPS=1.000:1.000) and also 2.33 g 4-phenylphenol (0.0137 mol) were dissolved in 695 ml NMP under an argon atmosphere and converted, with the effect of 95.48 g (0.6909 mol) dispersed, in particular fine-particle potassium carbonate, in the presence of 90 g commercial xylene as entrainer, to form a chain-regulated polyphenylene sulfone which was methylated subsequently, as described below, with gaseous methylchloride. The speed of rotation of the agitator was set in all phases of the polymer production to 300 rpm. Firstly, the resulting water was removed with the entrainer from the reaction mixture during 150 minutes at a temperature of 190° C. A large part of the entrainer was returned thereby into the autoclave via the water separator. This process is subsequently termed “de-watering”. At the end of this process step, a sample of the polymer solution, which is sufficient for measurement of the viscosity number, was extracted (sample 1). Thereafter the excess commercial xylene was distilled off within 70 minutes at 185-200° C. and a sample was removed at the end of the distillation (sample 2). This process step is subsequently termed “entrainer distillation”. Finally, at a temperature of 190° C., methylchloride was conveyed overhead for 60 minutes and thereafter a sample was again extracted (sample 3). This process step is subsequently termed “methylation”. The three samples were prepared according to the above-described procedure. Measurement of the viscosity (VN) of each of the three samples according to the above-indicated method produced the following values.

| | VN [ml/g] |
|---|---|
| Sample 1: | 59 |
| Sample 2: | 76 |
| Sample 3: | 78 |

The time required in total for the polymer production was 280 minutes. There is understood by this time provided nothing different is defined subsequently the sum of the above-mentioned process steps “de-watering”, “entrainer distillation” and “methylation”, it is subsequently termed process duration. In the case of some examples and comparative examples, not all of the process steps were implemented or the step “methylation” was implemented differently from the above specification, the process duration and implementation of the “methylation” step was defined specially in the relevant examples and comparative examples.

For examination of the polymer stability, the salt-containing PPSU solution which remained after removal of the three samples was cooled to 175° C. and agitated with further overhead conveyance of inert gas at a reduced speed of rotation (60 rpm). After 24 h, 48 h and 72 h, samples (A-C) were extracted, processed according to the above-described method and the viscosity number of the thus obtained PPSU was determined according to the above-indicated method. The following results were obtained:

| | VN [ml/g] |
|---|---|
| Sample A: | 78 |
| Sample B: | 78 |
| Sample C: | 78 |

The glass transition temperature of sample C was determined as described above. This was 227° C. (onset: 225° C.).

### Comparative Example 1

### CE 1, Equimolar Use of Components A and B, No Chain Regulator, Commercial Xylene as Entrainer

In the same way as described under example 1, with the exception of 4-phenylphenol, the same quantities of the above-indicated components were converted to form a polyphenylene sulfone, likewise 90 g commercial xylene was used as entrainer. The process step of methylation was not carried out. The individual process steps were implemented under the following conditions. After de-watering and after the entrainer distillation, samples were taken and processed as described above (samples 1 and 2).
De-Watering:
Duration: 150 minutes/temperature: 190° C. (sample 1)
Entrainer Distillation:
Duration: 65 minutes/temperature: 185-200° C. (sample 2)

The measurement of the viscosity number (VN) of the samples according to the above-described method produced the following values:

| | VN [ml/g] |
|---|---|
| Sample 1: | 85 |
| Sample 2: | 93 |

The process duration (sum of the time spent on de-watering and entrainer distillation) was 215 minutes.

Examination of the polymer stability was not implemented in this case since the viscosity number of the polymer obtained after the polycondensation was already unusably high for practical applications.

### Comparative Example 2

### CE 2, Use of an Excess of the Dihydroxyaryl Component, No Chain Regulator, Xylene as Entrainer and Methylation

In the same way as described under example 1, 127.3 g (0.684 mol) 4,4′-dihydroxybiphenyl and 192.1 g (0.669 mol) 4,4′-dichlorodiphenyl sulfone (molar ratio DHDP:DCDPS=1.022:1.000) was dissolved in 695 ml NMP and converted, under the effect of 95.27 g (0.6893 mol) dispersed, in particular fine-particle potassium carbonate in the presence of 90 g commercial xylene as entrainer, to form a polyphenylene sulfone. The individual steps of the polymer production were implemented under the following conditions. After de-watering (sample 1), at the end of the 1^{st} methylation (sample 2) and at the end of the 2^{nd} methylation (sample 3), samples were taken and processed according to the above-indicated method. The two methylation steps were effected respectively by triple application of methylchloride, pressures of at most 3-4 bar being set in the autoclave.
De-watering: Duration: 120 minutes/temperature: 190° C. (sample 1)
Entrainer distillation: Duration: 85 minutes/temperature: 185-200° C.
2^{nd} Methylation: Duration: 30 minutes/temperature: 185° C. (sample 3)

The process duration (sum of the time spent on the process steps of de-watering, 1^{st} methylation, entrainer distillation and 2^{nd} methylation) was 265 minutes.

Determination of the viscosity number according to the above-indicated method produced the following values:

| | VN [ml/g] |
|---|---|
| Sample 1: | 62 |
| Sample 2: | 63.5 |
| Sample 3: | 65 |

For examination of the polymer stability, the salt-containing PPSU solution, which remained after removing the three samples, was cooled to 175° C. and agitated with further overhead conveyance of inert gas at a reduced speed of rotation (60 rpm). After 24 h and 72 h, samples were extracted and processed and analysed as indicated above.

| | VN [ml/g] |
|---|---|
| Sample A (24 h): | 65 |
| Sample B (72 h): | 62.5 |

The values for the viscosity number remained stable.

As described above, the glass transition temperature of sample B was determined. This was 223° C. (onset 221° C.).

### Comparative Example 3

### CE 3, Use of an Excess of the Dichlorodiaryl Sulfone Component, No Chain Regulator and Commercial Xylene as Entrainer

In the same way as described under example 1, 127.3 g (0.684 mol) 4,4′-dihydroxybiphenyl and 202.7 g (0.706 mol) 4,4′-dichlorodiphenyl sulfone (molar ratio DHDP:DCDPS=0.969:1.000) was dissolved in 695 ml NMP and converted, under the effect of 98.55 g (0.7131 mol) dispersed, in particular fine-particle potassium carbonate in the presence of 90 g commercial xylene as entrainer, to form a polyphenylene sulfone. Since it hereby concerns a PPSU with a high excess of chlorophenyl end groups, no methylation was implemented. The process steps of de-watering and entrainer distillation were implemented under the following conditions:
De-watering: Duration: 280 minutes/temperature: 190° C.
Entrainer distillation: Duration: 25 minutes/temperature: 190-200° C.

The sample (sample 1) extracted after the entrainer distillation was processed as described above and the viscosity number (VN) was determined according to the above-indicated method.

| | VN [ml/g] |
|---|---|
| Sample 1 (after entrainer distillation) | 63.5 |

The process duration (sum of the time spent on de-watering and entrainer distillation) was 305 minutes.

For examination of the polymer stability, the salt-containing PPSU solution, which remained after removal of the three samples, was cooled to 175° C. and agitated with further overhead conveyance of inert gas at a reduced speed of rotation (60 rpm). After 24 h, 48 h and 72 h, the samples A-C were extracted, processed according to the above-described method and the viscosity number was measured as indicated above. The following results were obtained:

| | VN [ml/g] |
|---|---|
| Sample A (24 h): | 71 |
| Sample B (48 h): | 82.5 |
| Sample C (72 h): | 93.5 |

As the measuring values show, the viscosity increased greatly with increasing dwell time in the reactor. Filtration of the samples could be implemented, as a result of the higher viscosity number, only after dilution thereof with up to triple the NMP quantity.

### Comparative Example 4

### CE 4, Use of an Excess of the Dichlorodiaryl Sulfone Component, No Chain Regulator, Commercial Xylene as Entrainer and Methylation

In the same way as described under example 1, 127.3 g (0.684 mol) 4,4′-dihydroxybiphenyl and 202.7 g (0.706 mol) 4,4′-dichlorodiphenyl sulfone (molar ratio DHDP:DCDPS=0.969:1.000) were dissolved in 695 ml NMP and converted, under the effect of 98.55 g (0.7131 mol) dispersed, in particular fine-particle potassium carbonate in the presence of 90 g commercial xylene as entrainer, to form a polyphenylene sulfone. In addition, the methylation was implemented in 2 steps, analogously to comparative example 3. The process steps of de-watering, 1^{st} methylation, entrainer distillation and 2^{nd} methylation were implemented under the following conditions:
De-watering: Duration: 280 minutes/temperature: 190° C. (sample 1)
1^{st} Methylation: Duration: 30 minutes/temperature: 185° C. (sample 2)
Entrainer distillation: Duration: 30 minutes/temperature: 185-200° C.
2^{nd} Methylation: Duration: 30 minutes/temperature: 185° C. (sample 3)

The sample (sample 1) extracted after the entrainer distillation was processed as described above and the viscosity number (VN) was determined according to the above-indicated method.

| | VN [ml/g] |
|---|---|
| Sample 1: | 64 |

The process duration (sum of the time spent on de-watering, entrainer distillation and the two methylation steps) was 370 minutes.

For examination of the polymer stability, the salt-containing PPSU solution, which remained after removal of the three samples, was cooled to 175° C. and agitated with further overhead conveyance of inert gas at a reduced speed of rotation (60 rpm). After 24 h, 48 h and 72 h, samples A-C were extracted, processed according to the above-described method and the viscosity number was measured as indicated above. The following results were obtained:

| | VN [ml/g] |
|---|---|
| Sample A (24 h): | 69 |
| Sample B (48 h): | 78.5 |
| Sample C (72 h): | 87 |

As the measuring values show, the viscosity also increased greatly after implementation of methylation with increasing dwell time in the reactor. The filtration of the samples could be effected, as a consequence of the higher viscosity number, only after dilution thereof with up to triple the NMP quantity.

### Comparative Example 5

### CE 5, Equimolar Use of Components A and B, 4-Phenylphenol as Chain Regulator, Toluene as Entrainer and Methylation

In the same way as described under example 1, the same quantities of the components indicated there were converted to form a polyphenylene sulfone, however 90 g toluene was used as entrainer. The process step of methylation was likewise carried out as described in example 1. The individual process steps were implemented under the following conditions. After de-watering, after methylation and after entrainer distillation, samples were taken and processed as described above (samples 1 to 3).
De-watering: Duration: 150 minutes/temperature: 190° C. (sample 1)
Entrainer distillation: Duration: 75 minutes/temperature 185-200° C. (sample 2)
Methylation: Duration: 60 minutes/temperature 190° C. (sample 3)

Measurement of the viscosity number (VN) of the samples according to the above-described method produced the following values:

| | VN [ml/g] |
|---|---|
| Sample 1: | 30 |
| Sample 2: | 32 |
| Sample 3: | 34 |

The process duration was 285 minutes.

The obtained sulfone had more of an oligomeric than polymeric character, for which reason no stability test was implemented.

### EXAMPLE 2

### E 2, Equimolar Use of Components A and B, 4-Phenylphenol as Chain Regulator, No Entrainer and Methylation

In the same way as described under example 1, the same quantities of the components indicated there were converted to form a polyphenylene sulfone, however this time without entrainer. The water produced during the polycondensation was hereby distilled off within 6 hours directly out of the reactor. The water vapour was thereby conducted via a line heated to 110-120° C. to a reflux cooler with water separator. The individual process steps were implemented under the following conditions.
De-watering: duration: 360 minutes/temperature: 195° C.
Methylation: duration: 60 minutes/temperature: 195° C.

After the methylation, a sample (sample 1) was taken, processed according to the above-described method and the viscosity number was determined according to the above-indicated method. The following viscosity number was measured:

| | VN [ml/g] |
|---|---|
| Sample 1: | 79 |

The process duration (sum of the time required for de-watering and methylation) was 420 minutes.

For examination of the polymer stability, the salt-containing PPSU solution, which remained after removal of the sample, was cooled to 175° C. and agitated with further overhead conveyance of inert gas at a reduced speed of rotation. After 24 h, 48 h and 72 h, samples (A-C) were extracted, processed according to the above-described method and the viscosity number of the thus obtained PPSU was measured according to the above-indicated method. The following results were obtained:

| | VN [ml/g] |
|---|---|
| Sample A: | 79 |
| Sample B: | 79 |
| Sample C: | 79 |

The process duration at 420 minutes is in fact significantly higher than if commercial xylene is used as entrainer. However, a polysulfone with a viscosity number in the range suitable for applications is also obtained without using an entrainer.

### Comparative Example 6

### CE 6, Equimolar Use of Components A and B, 4-Chlorodiphenyl Sulfone as Chain Regulator, Commercial Xylene as Entrainer and Methylation

In the same way as described under example 1, with the exception of 4-phenylphenol, the same quantities of the components indicated there were converted to form a polyphenylene sulfone, likewise 90 g commercial xylene was used as entrainer. Instead of 4-phenylphenol, 3.46 g (0.0137 mol) 4-chlorodiphenyl sulfone was used. The process step of methylation was not carried out because of the greatly reduced hydroxy end groups. The individual process steps were implemented under the following conditions. After de-watering and after entrainer distillation, samples were taken and processed as described above (samples 1 to 2).
De-watering: Duration: 150 minutes/temperature: 190° C. (sample 1)
Entrainer distillation: Duration: 75 minutes/temperature: 185-200° C. (sample 2)
   The process duration was 215 minutes.

Measurement of the viscosity number (VN) of the two samples according to the above-described method produced the following values:

| | VN [ml/g] |
|---|---|
| Sample 1: | 44 |
| Sample 2: | 60 |

For examination of the polymer stability, the salt-containing PPSU solution, which remained after removal of the three samples, was cooled to 175° C. and agitated with further overhead conveyance of inert gas at a reduced speed of rotation. After 24 h, 48 h and 72 h, samples (A-C) were extracted, processed according to the above-described method and the viscosity number of the thus obtained PPSU was measured according to the above-indicated method. The following results were obtained:

| | VN [ml/g] |
|---|---|
| Sample A: | 83 |
| Sample B: | 85 |
| Sample C: | 93 |

It emerges from comparative example 7 that the use of 4-chlorodiphenyl sulfone as regulator leads to a polysulfone which synthesises in the stability test as far as viscosity numbers which are above the range suitable for applications.

TABLE
Overview of the results

| | E 1 | CE 1 | CE 2 | CE 3 | CE 4 | CE 5 | E 2 | CE 6 |
|---|---|---|---|---|---|---|---|---|
| Polymer | PPSU | PPSU | PPSU | PPSU | PPSU | PPSU | PPSU | PPSU |
| Molar ratio | 1.000:1.000 | 1.000:1.000 | 1.022:1.000 | 0.969:1.000 | 0.969:1.000 | 1.000:1.000 | 1.000:1.000 | 1.000:1.000 |
| DHBP:DCDPS | | | | | | | | |
| Quantity 4-phenylphenol | 50 | — | — | — | — | 50 | 50 | — |
| [μmol/g^{a}] | | | | | | | | |
| Quantity 4-chlorodiphenyl | — | — | — | — | — | — | — | 50 |
| sulfone [μmol/g^{a}] | | | | | | | | |
| Solvent | NMP | NMP | NMP | NMP | NMP | NMP | NMP | NMP |
| Entrainer | xylene^{b} | xylene^{b} | xylene^{b} | xylene^{b} | xylene^{b} | toluene | — | xylene^{b} |
| De-watering [min] | 150 | 150 | 120 | 280 | 280 | 150 | 360 | 150 |
| 1^{st} methylation [min] | — | — | 30 | — | 30 | — | 60 | — |
| Entrainer distillation [min] | 70 | 65 | 85 | 25 | 30 | 75 | — | 75 |
| 2^{nd} methylation [min] | 60 | — | 30 | — | 30 | 60 | — | — |
| Process duration [min] | 280 | 215 | 265 | 305 | 370 | 285 | 420 | 215 |
| Viscosity number [ml/g] | | | | | | | | |
| Production: | | | | | | | | |
| Sample 1: | 59 | 85 | 62 | 63.5 | 64 | 30 | 79 | 44 |
| Sample 2: | 76 | 93 | 63.5 | — | — | 32 | — | 60 |
| Sample 3: | 78 | — | 65 | — | — | 34 | — | — |
| Stability test: | | | | | | | | |
| Sample A: | 78 | — | 65 | 71 | 69 | — | 79 | 83 |
| Sample B: | 78 | — | 62.5 | 82.5 | 78.5 | — | 79 | 85 |
| Sample C: | 78 | — | — | 93.5 | 87 | — | 79 | 93 |
| Glass transition temperature | 227° C. | n.m. | 223° C. | n.m. | n.m. | n.m. | n.m. | n.m. |

^{a}μmol regulator relative to g produced polymer;
^{b}commercial xylene

1. A method for the production of polysulfone polymers, in which a component A, comprising at least one aromatic dihydroxy compound, selected from the group consisting of 4,4′-dihydroxybiphenyl and bisphenol S, is converted with a component B, comprising at least one bis-(haloaryl)sulfone in the presence of a base which reacts with the reaction mixture under formation of water, wherein
>0.99 to <1.01 equivalents of component A are utilized relative to 1.0 equivalent of component B, the conversion is implemented in a solvent, comprising N-alkylated pyrrolidones,
from 0 to 12 percent by weight of at least one entrainer with a boiling point of greater than 130° C., is added to the reaction mixture and
at least one regulator (component D) which is a monovalent phenol is added during and/or after the conversion of component A with component B.

2. The method according to claim 1, wherein the component D is a monovalent phenol with a PKₐ value of the phenolic proton of <12.

3. The method according to claim 1, wherein component D, relative to the weight sum of the produced polymer used, is up to 30-90 μmol/g.

4. The method according to claim 1, wherein, during and/or after conversion of component A with component B, partial or complete de-watering of the reaction mixture is effected.

5. The method according to claim 1, wherein the entrainer is utilized in a quantity of 4 to 12 percent by weight, relative to the total weight of all the components of the reaction mixture.

6. The method according to claim 1, wherein the entrainer with a boiling point of greater than 130° C. is selected from alkyl aromatic compounds.

7. The method according to claim 1, wherein >0.995 to <1.005 equivalent of component A, relative to 1.0 equivalent of component B are utilized.

8. The method according to claim 1, during and/or after the conversion of component A and B, at least once a component C, which is an aliphatic monochlorine compound is added to the reaction mixture to carry out alkylation.

9. The method according to claim 1, wherein, before the addition and conversion of component C and/or of component D, at least part or the entirety of the water formed is removed from the reaction mixture and/or, after the conversion of component C and/or of component D, complete removal of the entrainer from the reaction mixture is effected.

10. The method according to claim 1, wherein the base is selected from the group consisting of alkali- or alkaline earth hydrogen carbonates, alkali- or alkaline earth carbonates or mixtures thereof.

11. The method according to claim 1, wherein 1.0 to 1.5 equivalents of the base relative to 1.0 equivalent of component, A are utilized.

12. The method according to claim 1, wherein the conversion of component A with component B is implemented under an inert gas atmosphere.

13. The method according to claim 1, wherein the sum of 4,4′-dihydroxybiphenyl and/or bisphenol S makes up at least 50 percent by weight of component A.

14. The method according to claim 1, wherein component A is 4,4′-dihydroxybiphenyl or 4,4′-bisphenol S.

15. The method according to claim 1, the process duration, by which the entire duration for the steps of de-watering, entrainer distillation and alkylation is understood, is
a) below 400 minutes, or
b) below 450 minutes.

16. A polysulfone polymer produced according to the method of claim 1.

17. The polysulfone polymer according to claim 16, with a glass transition temperature T_{g}, measured according to ISO 11357 part 1 and 2 of more than 223° C.

18. A thermoplastic moulding compound, comprising at least one polysulfone polymer in accordance with claim 16.

19. A moulded article, produced from a thermoplastic moulding compound in accordance with claim 18, in the form of fibres, films, membranes or foams.

20. A method of producing moulded articles, fibres, films, membranes or foams comprising utilizing the polysulfone polymer and/or thermoplastic moulding compound according to claim 1.

21. The method according to claim 2, wherein the phenol is selected from the group consisting of 4-phenylphenol, 4-tert-butylphenol, 4-tritylphenol, ortho-cresol, meta-cresol, para-cresol, 2,3-dimethylphenol, 2,4-dimethylphenol, 2,5-dimethylphenol, 2,6-dimethylphenol, 3,4-dimethylphenol, 3,5-dimethylphenol, mesitol, tymol, para-amylphenol, ortho-amylphenol, meta-amylphenol, para-isopropylphenol, meta-isopropylphenol, ortho-isopropylphenol, para-n-butylphenol, ortho-n-butylphenol, meta-n-butylphenol, para-n-heptylphenol, para-n-heptylphenol, meta-n-heptylphenol, para-n-octylphenol, ortho-n-octylphenol, meta-n-octylphenol, para-n-nonylphenol, ortho-n-nonylphenol, meta-n-nonylphenol, para-n-dodecylphenol, meta-n-dodecylphenol, ortho-n-dodecylphenol, 5-indanol, 1-hydroxynaphthalene, and 2-hydroxynaphthalene.
